(19) United States
(12) Patent Application Publication
(10) Pub. No.: US 2003/0016488 A1
(43) Pub. Date: Jan. 23, 2003

(54) Multi-function portdock

(75) Inventor: Ching-Chi Huang, Hsinchu (TW)

Correspondence Address: BACON & THOMAS, PLLC, 625 SLATERS LANE, FOURTH FLOOR, ALEXANDRIA, VA, 22314

(73) Assignee: Winbond Electronics Corp., Hsinchu (TW)

(21) Appl. No.: 10/162,557

(22) Filed: Jun. 6, 2002

(30) Foreign Application Priority Data
Jun. 13, 2001 (TW) 90114228

(51) Int. Cl. G06F 1/16

(52) U.S. Cl. 361/683; 361/686

(57) ABSTRACT

A multi-function portdock for connecting a first I/O card and a second I/O card of a desktop computer to a panel of said desktop computer directly is proposed. The multi-function portdock comprises: a body installed in said desktop computer for showing a surface of said body on said panel of said desktop computer; a first I/O slot installed on said surface of said body for containing said first I/O card, when said first I/O card is inserted into said first I/O slot, signals can be transmitted to said desktop computer; a second I/O slot installed on said surface of said body for containing said second I/O card, when said second I/O card is inserted into said second I/O slot, signals can be transmitted to said desktop computer.

### FIELD OF THE INVENTION

The present invention is related to a multi-function portdock, and more particularly to a portdock with various numbers of I/O card's slots and I/O ports, which can be installed on a panel of a desktop computer for making the desktop computer can be connected to I/O cards and peripheral devices directly.

### BACKGROUND OF THE INVENTION

Normal computers only support some standard peripheral devices. For example, devices installed on the rear side of a computer are one parallel port, two serial ports, and two USB ports . . . etc. And devices installed on the front side of a computer are a FDD, a HDD, a CD-ROM drive (or CDR/W) . . . etc. If other I/O peripheral devices are added, data will be converted by available ports.

Therefore, many products are manufactured for this reason. For example, COM Port Smart Card Reader (USB Smart Card Reader) can convert data through a serial port or a USB port; Parallel port Scanner (USB Scanner) can convert data through a parallel port or a USB port; CDR/W can convert data through parallel port; and Memory Stick produced by Sony, which has various kinds of convert interfaces. However, those mentioned products are required to convert data so that data can be transmitted to CPU correctly to process. And some of them are required to transmit results to peripheral devices. This kind of product usually consists of a micro control chip and other special parts. Sometimes its functions are limited by the bandwidth of ports. And if special style is required, increasing the cost of making a mold is necessary. Because high costs of parts, this kind of product's price is high at the beginning. If the function of this device is necessary, users have to pay a lot of money to acquire this convenience. That's not reasonable.

Now, if only a I/O control chip having a built-in Smart Card (Memory Stick™ produced by Sony) and a built-in SD (SD Memory Card™ produced by Panasonic) is adopted to the motherboard of a computer, data can be transmitted without a complicated convert interface and it costs less. As to connectors, most computers have two or three extension slots, which are used to install two 3.5 disk drives. Most computers are equipped with only one disk drive, or even no disk drive, so this space is not used. According to the present invention, the disk drive extension slots reserved in the normal computer are used to install the multi-function portdock. Because no expensive part is inside, and making a new mold and modifying devices of a computer are not necessary, the cost is low and users can assemble it by their own. Therefore, it will be a standard part in the early future.

### SUMMARY OF THE INVENTION

An object of the present invention is to provide a multi-function portdock installed on a panel of a desktop computer for connecting a first I/O card and a second I/O card of a desktop computer to the panel directly.

Another object of the present invention is to provide a body installed in the desktop computer for showing a surface of the body on the panel of the desktop computer.

Another object of the present invention is to provide a first I/O slot installed on the surface of the body for containing the first I/O card, when the first I/O card is inserted into the first I/O slot, signals can be transmitted to the desktop computer.

Another object of the present invention is to provide a second I/O slot installed on the surface of the body for containing the second I/O card, when the second I/O card is inserted into the second I/O slot, signals can be transmitted to the desktop computer.

According to the present invention, a multi-function portdock can integrate various kinds of slots such as the first I/O slot, the second slot and so on. And when it is installed on the panel of a computer, peripheral devices and I/O cards can be inserted into panels directly. And the structure of its body is simple, so it can achieve the purpose of saving the cost. The multi-function portdock comprises: a body installed in the desktop computer for showing a surface of the body on the panel of the desktop computer; a first I/O slot installed on the surface of the body for containing the first I/O card, when the first I/O card is inserted into the first I/O slot, signals can be transmitted to the desktop computer; and a second I/O slot installed on the surface of the body for containing the second I/O card, when the second I/O card is inserted into the second I/O slot, signals can be transmitted to the desktop computer.

In accordance with one aspect of the present invention, the first I/O card is a Smart Card.

In accordance with one aspect of the present invention, the second I/O card is a Memory Stick (MS).

In accordance with one aspect of the present invention, the second I/O card contains a Memory Card.

In accordance with one aspect of the present invention, the Memory Card is a SD Card.

In accordance with one aspect of the present invention, the first I/O slot contains a first connector for making the first I/O card transmit signals to the desktop computer.

In accordance with one aspect of the present invention, the second I/O slot contains a second connector for making the second I/O card transmit signals to the desktop computer.

In accordance with one aspect of the present invention, the multi-function portdock contains several I/O slots.

In accordance with one aspect of the present invention, the I/O slots contain 2 USB slots.

Furthermore, a multi-function portdock can be installed on a panel of a desktop computer for connecting a first peripheral device and a second peripheral device of the desktop computer to the panel directly. The multi-function portdock comprises: a body installed in the desktop computer for showing a surface of the body on the panel of the desktop computer; a first I/O port installed on the surface of the body for connecting the first peripheral device, when the first peripheral device is connected to the first I/O port, signals can be transmitted to the desktop computer; and a second I/O port installed on the surface of the body for containing the second peripheral device, when the second peripheral device is inserted into the second I/O port, signals can be transmitted to the desktop computer.

In accordance with one aspect of the present invention, the multi-function portdock according to claim 10 wherein the first I/O port is a USB port.

In accordance with one aspect of the present invention, the multi-function portdock according to claim 10 wherein the second I/O port is an IR port.

In accordance with one aspect of the present invention, the multi-function portdock according to claim 10 wherein the peripheral devices contain a Smart Card, a Memory Stick (MS), and a Memory Card.

In accordance with one aspect of the present invention, the multi-function portdock according to claim 13 wherein the I/O ports are slot-shaped for containing the Smart Card, the Memory Stick (MS), and the Memory Card.

In accordance with one aspect of the present invention, the multi-function portdock according to claim 10 wherein the I/O ports contain a connector for making the peripheral devices transmit signals to the desktop computer.

In accordance with one aspect of the present invention, the multi-function portdock according to claim 10 wherein the multi-function portdock is suitable for a 3.5 inch disk drive case.

The present invention may best be understood through the following description with reference to the accompanying drawings, in which:

### BRIEF DESCRIPTION OF THE DRAWINGS

FIG. 1 is an internal structure illustration of a multi-function portdock according to the present invention;

FIG. 2 is an appearance illustration of the multi-function portdock according to the present invention;

FIG. 3(A)˜(C) is a variation illustration of the multi-function portdock's panel design according to the present invention;

FIG. 4 is an illustration of the multi-function portdock connected to system according to the present invention; and

FIG. 5 is an appearance illustration of the multi-function portdock installed on a desktop computer according to the present invention.

### DETAILED DESCRIPTION OF THE PREFERRED EMBODIMENT

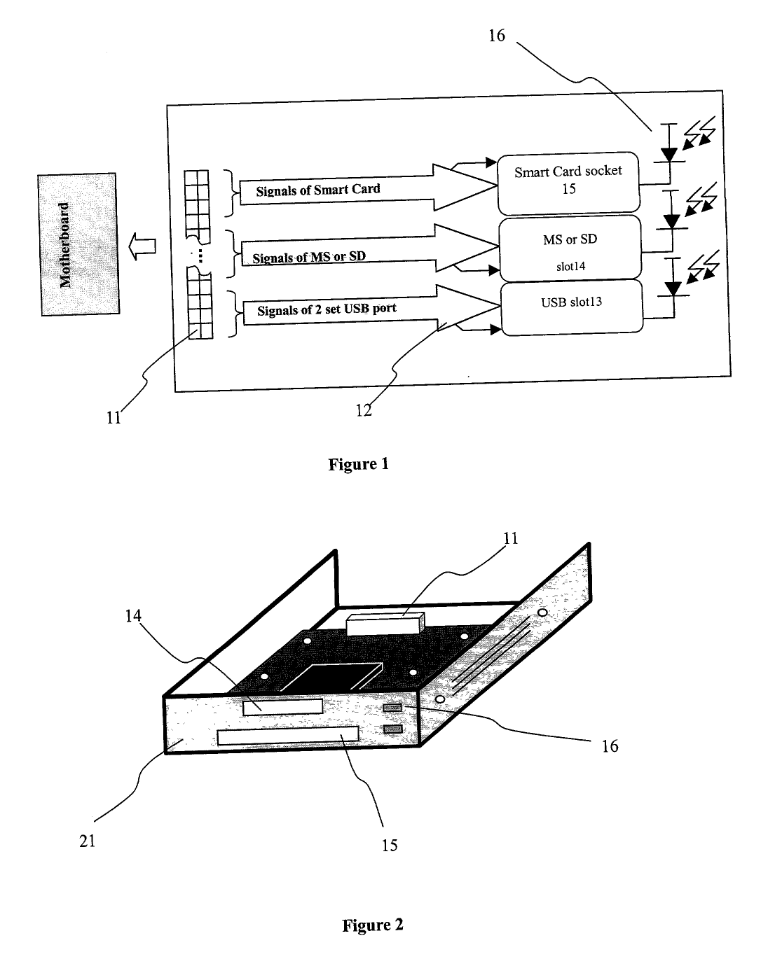

Please refer to FIG. 1 showing the internal structure illustration of the multi-function portdock. The multi-function portdock has a case whose size is the same as that of a 3.5 FDD, and a PCB with various built-in slots. The circuit board of the multi-function portdock comprises: (its cost is low)

1. Multi-function connector 11: This connector can be 10 Pins, 20 Pins, or 30 Pins. The function of this device can be modified by the type of a connector. For example, the 10 Pins connector only can support a PC Smart Card; the 20 Pins connector can support a PC Smart Card, a MS(Memory Stick™ produced by Sony), or a SD(SD Memory Card™ produced by Panasonic). The 30 Pins connector can support a PC Smart Card, a MS, and a SD at the same time.

Furthermore 10 Pins can be added as two USB port slots. In other words, multi-function connector 11 contains a first connecor and a seccond connector supporting different peripheral devices.

2. Several Power MOS Transistors 12: Those Power MOS Transistors are used to switch on/off the power of the Smart Card, the MS, and the USB port.

3. A Smart Card Socket15, a MS Slot14 and a USB slot13.

4. A small number of resistors and capacitors used to setup signals and filter circuits.

5. Some LEDs16.

FIG. 2 shows the appearance illustration of the multi-function portdock according to the present invention. The hight and the width of a portdock can be designed to be the same as those of 3.5 inch disk drive, so the available space of computer case can be utilized. A Smart Card socket15, a MS slot 14 and two LEDs 16 can be seen on the panel of portdock 21. The internal multi-function connector 11 can be used to connect to the motherboard of a computer. According to the present inventor, there are only simple contacts in the portdock. And this portdock transmits signals from every device to the motherboard. The control chip set of the motherboard can process those signals. Therefore, the cost of the portdock would be reduced.

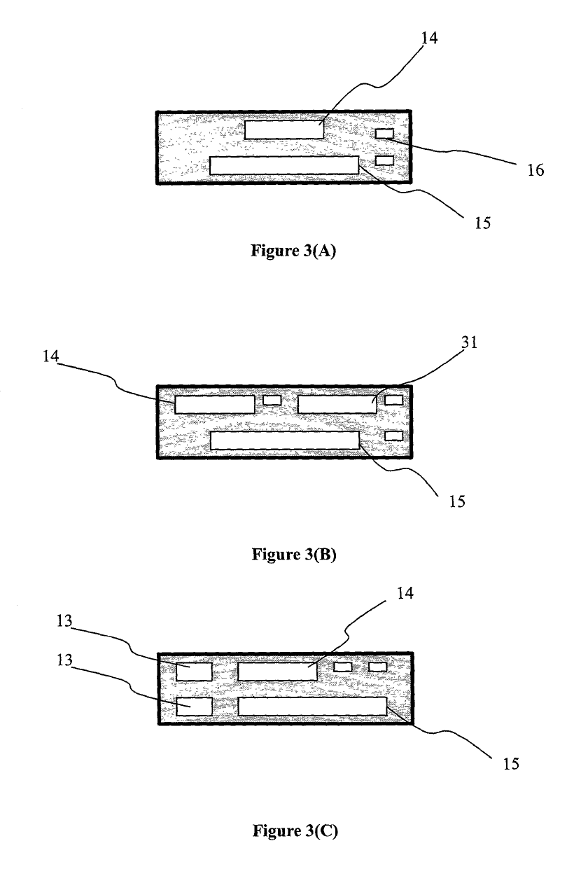

FIG. 3(A)˜(C)shows the variation illustration of the multi-function portdock's panel design according to the present invention. There are one MS slot 14, one Smart Card socket 15, and two LEDs 16 in FIG. 3(A). FIG. 3(B) shows a device which can support a MS slot 14, a Smart Card socket 15, and a SD Memory Card slot 31. FIG. 3(C) shows a device which can support two USB slots, one MS slots 14, and one Smart Card socket 15.

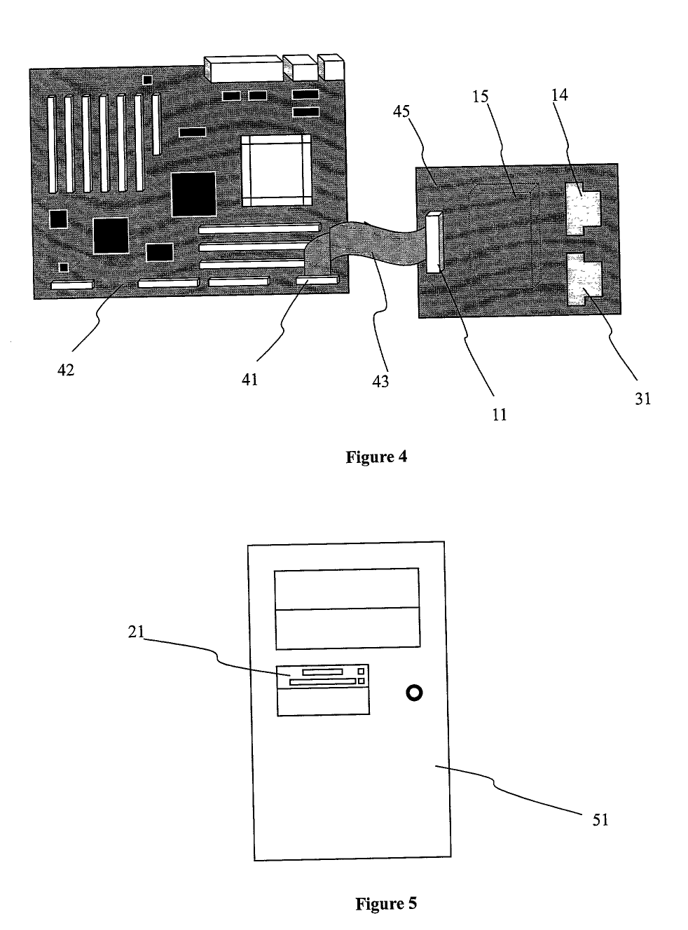

FIG. 4 shows the illustration of the multi-function portdock connected to system according to the present invention. A round cable 43 can be used to connect the connector 41 of the motherboard 42 to the connector 11 of this multi-function portdock. It is very easy to assemble. The relative position of a Smart Card 15, a MS 14, and a SD 31 are marked on the circuit board 45 of the multi-function portdock.

FIG. 5 shows the appearance illustration of the multi-function portdock installed on a desktop computer according to the present invention. This multi-function portdock is installed in a computer 51 whose panel are increased various kinds of slots of the multi-function portdock panel 21, and it can provide users a convenient operating environment.

The advantages according to the present invention are as follows:

1. Saving the cost of making a new mold by integrating various slots of I/O ports on a single portdock.

2. Enhancing the using convenience by installing slots of devices(such as those of a memory card . . . etc.) on the panel of a computer.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-function portdock installed on a panel of a desktop computer for connecting a first I/O card and a second I/O card of said desktop computer to said panel directly, said multi-function portdock comprising:
a body installed in said desktop computer for showing a surface of said body on said panel of said desktop computer;
a first I/O slot installed on said surface of said body for containing said first I/O card, when said first I/O card being inserted into said first I/O slot, signals being transmitted to said desktop computer; and
a second I/O slot installed on said surface of said body for containing said second I/O card, when said second I/O card being inserted into said second I/O slot, signals being transmitted to said desktop computer.

2. A multi-function portdock according to claim 1 wherein said first I/O card is a Smart Card.

3. A multi-function portdock according to claim 1 wherein said second I/O card is a Memory Stick (MS).

4. A multi-function portdock according to claim 3 wherein said second I/O card contains a Memory Card.

5. A multi-function portdock according to claim 4 wherein said Memory Card is a SD Card.

6. A multi-function portdock according to claim 1 wherein said first I/O slot contains a first connector for making said first I/O card transmit said signals to said desktop computer.

7. A multi-function portdock according to claim 1 wherein said second I/O slot contains a second connector for making said second I/O card transmit said signals to said desktop computer.

8. A multi-function portdock according to claim 1 wherein said multi-function portdock contains several I/O slots.

9. A multi-function portdock according to claim 8 wherein said I/O slots contain 2 USB slots.

10. A multi-function portdock installed on a panel of a desktop computer for connecting a first peripheral device and a second peripheral device of said desktop computer to said panel directly, said multi-function portdock comprising:
a body installed in said desktop computer for showing a surface of said body on said panel of said desktop computer;
a first I/O port installed on said surface of said body for connecting said first peripheral device, when said first peripheral device being connected to said first I/O port, signals being transmitted to said desktop computer; and
a second I/O port installed on said surface of said body for containing said second peripheral device, when said second peripheral device being inserted into said second I/O port, signals being transmitted to said desktop computer.

11. A multi-function portdock according to claim 10 wherein said first I/O port is a USB port.

12. A multi-function portdock according to claim 10 wherein said second I/O port is an IR port.

13. A multi-function portdock according to claim 10 wherein said peripheral devices contain a Smart Card, a Memory Stick (MS), and a Memory Card.

14. A multi-function portdock according to claim 13 wherein said I/O ports are slot type ports for containing said Smart Card, said Memory Stick (MS), and said Memory Card.

15. A multi-function portdock according to claim 10 wherein said I/O ports contain a connector for making said peripheral devices transmit said signals to said desktop computer.

16. A multi-function portdock according to claim 10 wherein said multi-function portdock is suitable for a 3.5 inch disk drive case.
